(19) United States
(12) Patent Application Publication
(10) Pub. No.: US 2009/0198011 A1
(43) Pub. Date: Aug. 6, 2009

(54) POLYMER COMPOSITION CONTAINING FLAME RETARDANT AND PROCESS FOR PRODUCING THE SAME

(76) Inventors: Kailash DANGAYACH, Houston, TX (US); Hoe Hin Chuah, Houston, TX (US)

Correspondence Address: SHELL OIL COMPANY, P O BOX 2463, HOUSTON, TX, 772522463, US

(21) Appl. No.: 12/336,346

(22) Filed: Dec. 16, 2008

Related U.S. Application Data
(60) Provisional application No. 61/014,536, filed on Dec. 18, 2007.

(51) Int. Cl. C08L 61/00

(52) U.S. Cl. 524/502; 525/153

(57) ABSTRACT

A flame retardant polymer composition and a process for making the composition are provided. The flame retardant polymer composition is a poly(trimethylene terephthalate) co-polymer containing a trimethylene terephthalate monomer and a phosphorous containing flame retardant monomer. The flame retardant polymer composition is produced by a process in which the trimethylene terephthalate monomer or its precursors and the phosphorous containing flame retardant monomer or its precursors are combined to form the poly(trimethylene terephthalate) co-polymer in one or more pre-polymerization and polymerization steps.

This application claims the benefit of U.S. Provisional Application No. 61/014,536, filed Dec. 18, 2007, which is incorporated herein by reference.

### FIELD OF THE INVENTION

The present invention is directed to a flame retardant polyester co-polymer composition and a process for producing the composition. More particularly, the present invention is directed to a flame retardant poly(trimethylene terephthalate) co-polymer composition and a process for producing the same.

### BACKGROUND OF THE INVENTION

Flame retardants are frequently added to or incorporated in polymers to provide flame retardant properties to the polymers. The flame retardant polymers may then be used in applications in which resistance to flammability is desirable, for example, in textile or carpet applications.

A large variety of compounds have been used to provide flame retardancy to polymers. For example, numerous classes of phosphorous containing compounds, halogen containing compounds, and nitrogen containing compounds have been utilized as flame retardants in polymers. Classes of halogen containing compounds that have been used a flame retardants in polymers include polyhalogenated hydrocarbons. Classes of phosphorous containing compounds that have been used as flame retardants in polymers include inorganic phosphorous compounds such as red phosphorous, monomeric organic phosphorous compounds, orthophosphoric esters or condensates thereof, phosphoric ester amides, phosphonitrilic compounds, phosphine oxides (e.g. triphenylphosphine oxides), and metal salts of phosphinic, phosphoric, and phosphonic acids. The metal salts of phosphinic acids (metal salt phosphinates) that have been utilized as flame retardants in polymers comprise a large variety of compounds themselves, including monomeric, oligomeric, and polymeric species with one, two, three, or four phosphinate groups per coordination center including metals selected from beryllium, magnesium, calcium, strontium, barium, titanium, zirconium, vanadium, antimony, bismuth, chromium, molybdenum, tungsten, manganese, iron, ruthenium, cobalt, rhodium, iridium, nickel, platinum, palladium, copper, silver, zinc, cadmium, mercury, aluminum, tin, and lead.

Such flame retardant compounds have been used in a wide variety of polymers. For example, phosphorous containing compounds have been used as flame retardants in polymers such as polymers of mono- and di-olefins such as polypropylene, polyisobutylene, polyisoprene, and polybutadiene; aromatic homopolymers and copolymers derived from vinyl aromatic monomers such as styrene, vinylnaphthalene, and p-vinyltoluene; hydrogenated aromatic polymers such as polycyclohexylethylene; halogen containing polymers such as polychloroprene and polyvinylchloride; polymers derived from α,β-unsaturated acids and derivatives thereof such as polyacrylates and polyacrylonitriles; polyamides such as nylon-6 and nylon-6,6′; polysulfones; and polyesters such as polyethylene terephthalate (PET), and polybutylene terephthalate (PBT).

Poly(trimethylene terephthalate) (“PTT”) is a polyester that has recently been commercially developed as a result of the recent availability of commercial quantities of 1,3-propanediol, a requisite compound for forming PTT. PTT has an array of desirable characteristics when used in fiber applications relative to other polymers used in fiber applications such as polyamides, polypropylenes, and its polyester counterparts PET and PBT, such as soft touch, good stain resistance, and resilience and shape recovery due to its spring-like molecular structure.

It is desirable to provide PTT with effective flame retardant properties. In particular, it is desirable to provide a PTT polymer composition with effective flame retardant properties by incorporating an effective amount of flame retardant in a PTT polymer while retaining sufficient tensile strength so the PTT polymer may be utilized in the formation of PTT fibers, filaments, films and molding compositions. A PTT polymer having a low tensile strength may not have sufficient strength to be melt spun into a fiber or filament since the polymer may break as it is spun, or may not have sufficient strength to be formed into a molded composition since the polymer may collapse, or may not have sufficient strength to be stretched into a film.

The tensile strength of a polyester-flame retardant co-polymer may be negatively affected by the presence of a flame retardant co-monomer. For example, co-polymers comprising poly(ethylene terephthalate) (“PET”) and a flame retardant monomer have flame retardancy but reduced tensile strength. Synthesis and Characterization of Copolyesters Containing the Phosphorous Linking Pendent Groups, J. App. Polymer Sci., Vol. 72, 109-122 (1999) provides a flame retardant PET-co-poly(ethylene 9,10-dihydro-10[2,3-di-(hydroxy carbonyl)propyl]-10-phosphaphenanthrene-10-oxide) [“PET-co-PEDDP”] co-polymer. The flame retardant PET-co-PEDDP co-polymer provides improved flame retardant characteristics relative to a PET homopolyester. The PET-co-PEDDP co-polymer, however, has a significantly decreased tensile strength relative to the PET homopolyester, where inclusion of 0.7 wt. % of phosphorous (from the flame retardant) in the co-polymer reduces the tensile strength by a third relative to the PET homopolyester, and increasing levels of phosphorous from the flame retardant further decrease the tensile strength of the co-polymer.

### SUMMARY OF THE INVENTION

In one aspect, the invention is directed to a flame retardant polyester composition comprised of a polymer formed of from 50 mol % to 99.9 mol % of a trimethylene terephthalate component of formula (I) and from 0.1 mol % to 50 mol % of a phosphorous containing component of formula (II)

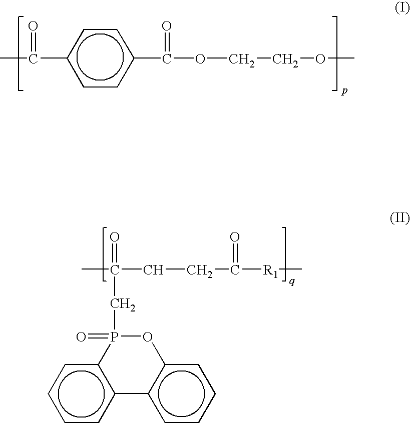

where p may be from 1 to 2500, q may be from 1 to 1250, and R₁ is an alkyl alcohol residuum having from 1 to 5 carbon atoms, an alkyl acid residuum having from 1 to 5 carbon atoms, an alkyl ester residuum having from 1 to 5 carbon atoms, or an oxygen atom, where the composition has a tensile strength of at least 45 MPa. In one embodiment of the invention, the co-polymer composition is a polymer molding, in another embodiment, the co-polymer composition is a film, in another embodiment the co-polymer composition is a filament, in yet another embodiment the co-polymer composition is a fiber, and in still another embodiment, the composition is a resin.

In another aspect, the invention is directed to a process for producing a flame retardant polyester, comprising: contacting 1) a trimethylene terephthalate containing material and 2) a phosphorous containing compound of Formula (IV)

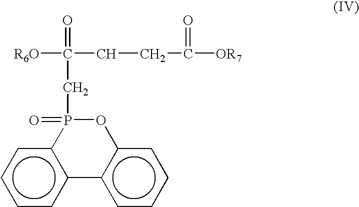

where R₆ and R₇ may be the same or different and are a hydrogen atom, an alkyl hydrocarbon group having from 1 to 5 carbons, or an alkyl alcohol group having from 1 to 5 carbons and one or more alcohol substituents at a temperature of from 230° C. to 280° C. and a pressure of from 0.01 kPa to 20 kPa (0.1 mbar to 50 mbar) for a period of time effective to form a poly(trimethylene terephthalate) co-polymer having an intrinisic viscosity of at least 0.7 dl/g and a tensile strength of at least 45 MPa, where the amounts of the trimethylene terephthalate containing material and the phosphorous containing compound are selected to provide a mole ratio of trimethylene terephthalate to the phosphorous containing compound of from 1:1 to 999:1.

In another aspect, the present invention is directed to a process for producing a flame retardant polyester, comprising, contacting 1,3-propanediol, a compound selected from the group consisting of terephthalic acid, dimethylterephthalate, and mixtures thereof, and a phosphorous containing compound of formula (IV)

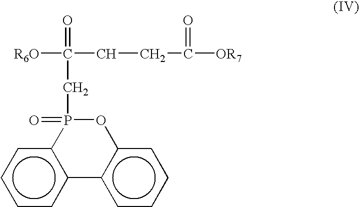

where R₆ and R₇ may be the same or different and are a hydrogen atom, an alkyl hydrocarbon group having from 1 to 5 carbon atoms, or an alkyl alcohol group having from 1 to 5 carbon atoms and one or more alcohol substituents at a temperature of from 235° C. to 280° C. and a pressure of from 70 kPa to 550 kPa to form an esterification product; treating the esterification product at a temperature of from 230° C. to 280° C. and a pressure of from 0.01 kPa to 20 kPa for a period of time effective to form a poly(trimethylene terephthalate) co-polymer having an intrinisic viscosity of at least 0.7 dl/g; wherein the amounts 1,3-propanediol, the compound selected from the group consisting of terephthalic acid, dimethylterephthalate, and mixtures thereof, and the phosphorous containing compound are selected to provide the poly(trimethylene terephthalate) co-polymer with from 50 mol % to 99.9 mol % trimethylene terephthalate monomer in the co-polymer.

In another aspect, the present invention is directed to a process for producing a flame retardant polyester, comprising: contacting 1,3-propanediol, a compound selected from the group consisting of terephthalic acid, dimethylterephthalate, and mixtures thereof, 9,10-dihydro-9-oxa-10-phosphaphenanthrene-10-oxide, itaconic acid, and optionally an alkyl alcohol having from 1 to 5 carbon atoms and having one or more alcohol substituents at a temperature of from 235° C. to 280° C. and a pressure of from 70 kPa to 550 kPa to form an esterification product; treating the esterification product at a temperature of from 230° C. to 280° C. and a pressure of from 0.01 kPa to 20 kPa for a period of time effective to form a poly(trimethylene terephthalate) co-polymer having an intrinisic viscosity of at least 0.7 dl/g; wherein the amounts 1,3-propanediol, the compound selected from the group consisting of terephthalic acid, dimethylterephthalate, and mixtures thereof, the 9,10-dihydro-9-oxa-10-phsphaphenanthrene-10-oxide, and the itaconic acid are selected to provide the poly(trimethylene terephthalate) co-polymer with from 50 mol % to 99.9 mol % trimethylene terephthalate monomer in the co-polymer.

### DETAILED DESCRIPTION OF THE INVENTION

The present invention provides a flame retardant PTT co-polymer composition wherein the flame retardant PTT co-polymer composition has sufficient tensile strength so the composition may be utilized in the formation of PTT fibers, filaments, films, and/or molding compositions. The composition of the present invention comprises a PTT co-polymer formed of a trimethylene terephthalate co-monomer and a phosphorous containing co-monomer that provides flame retardancy to the PTT co-polymer. The phosphorous-containing flame retardant co-monomer provides effective flame retardancy to the PTT co-polymer composition since 1) the flame retardant co-monomer component in the co-polymer composition has been found to provide effective flame retardancy in a PTT polymer without additional flame retardants; 2) the flame retardant co-monomer component is well dispersed in the co-polymer composition since it is co-polymerized into the polymer chain; and 3) the flame retardant co-monomer is not subject to being displaced from the co-polymer composition. Minimal amounts of the flame retardant co-monomer component may be required to provide effective flame retardance in the PTT co-polymer composition as a result of the substantially uniform distribution of the flame retardant co-monomer component in the PTT co-polymer.

The flame retardant PTT co-polymer composition of the present invention retains sufficient strength so the co-polymer may be utilized in the formation of PTT based fibers, filaments, films, and/or molding compositions since, unexpectedly, the PTT co-polymer containing a phosphorous containing flame retardant co-monomer component has a relatively high intrinsic viscosity and tensile strength. The flame retardant PTT co-polymer composition has an intrinsic viscosity of at least 0.7 dl/g, or at least 0.8 dl/g, or at least 0.9 dl/g, and has a tensile strength of at least 45 MPa. The relatively high intrinsic viscosity and tensile strength of the PTT co-polymer composition enables the composition to be melt spun into fibers or filaments, or to be used to form films or molding compositions. In addition, with respect to fiber formation from the flame retardant PTT co-polymer composition, the PTT co-polymer composition has sufficient flame retardancy that no additional flame retardant may be necessary, or, if an additional flame retardant component is added to the PTT co-polymer composition, the composition may contain at most 5 wt. % of an additional flame retardant while providing effective flame retardancy. The effective flame retardancy of the PTT co-polymer composition with no, or only minor amounts of, additional flame retardant permits the composition to be melt spun into fibers without breakage induced by addition of significant amounts of flame retardant to the composition.

The flame retardant PTT co-polymer composition of the present invention is comprised of a PTT containing co-polymer comprising at least 50 mol %, or at least 80 mol %, or at least 95 mol %, or at least 97 mol %, or from 50 mol % to 99.9 mol %, or from 70 mol % to 99.5 mol %, or from 80 mol % to 95 mol % of a trimethylene terephthalate component, shown as Formula (I),

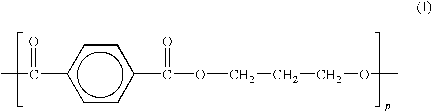

and greater than 0 mol % but at most 50 mol %, or at most 30 mol %, or at most 20 mol %, or at most 10 mol %, or from 0.1 mol % to 50 mol %, or from 0.5 mol % to 30 mol %, or from 5 mol % to 20 mol % of a phosphorous containing component of formula (II).

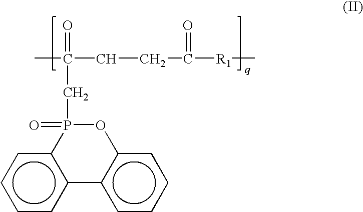

In formula (I), p may be from 1 to 2500, and preferably is from 4 to 250. In formula (II), q may be from 1 to 1250, or from 1 to 10, and preferably is from 1 to 5. In formula (II), R₁ may be an alkyl alcohol residuum having from 1 to 5 carbon atoms, an alkyl acid residuum having from 1 to 5 carbon atoms, an alkyl ester residuum having from 1 to 5 carbon atoms, or an oxygen atom. An alkyl alcohol residuum, as used herein, has the structure of —[R₂—O]—, where R₂ is a branched or linear hydrocarbon comprising 1 to 5 carbon atoms. An alkyl acid residuum and an alkyl ester residuum, as used herein, have the structure of

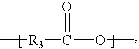

where R₃ is a branched or linear hydrocarbon comprising 1 to 4 carbon atoms. In one embodiment, R₁ may be —[CH₂—CH₂—CH₂—O]—. In another embodiment, R₁ may be —[CH₂—CH₂—O]—. In another embodiment, R₁ may be

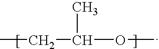

The flame retardant PTT containing co-polymer composition of the present invention may also contain minor amounts of monomers other than the trimethylene terephthalate component of formula (I) and the phosphorous containing component of formula (II). Such monomers include, but are not limited to, esterification products of one or more diols selected from the group consisting of ethylene glycol, 1,3-propanediol, 1,4-butanediol, 1,4-butenediol, and 1,4 cyclohexanedimethanol with a dicarboxylic acid selected from the group consisting of oxalic acid, succinic acid, phthalic acid, 2,6-naphthalenedicarboxylic acid, 5-sodiumsulfoisophthalic acid, isophthalic acid, adipic acid, terephthalic acid (except with 1,3-propanediol which would form a trimethylene terephthalate monomer), and mixtures thereof; or transesterification products of one or more of the diols listed above with one or more esters of one or more of the dicarboxylic acids listed above. The PTT containing co-polymer composition may contain up to 25 mol % of these monomers, or may contain at most 15 mol %, or at most 10 mol %, or at most 5 mol % of these monomers. The flame retardant PTT containing co-polymer composition of the present invention may also contain no monomers other than the trimethylene terephthalate component of formula (I) and the phosphorous containing component of formula (II).

Other polymers may be included in minor amounts in the flame retardant PTT containing co-polymer composition of the present invention along with the flame retardant PTT containing co-polymer. Polymers that may also be included in the flame retardant PTT containing co-polymer composition include polysulfones, polyesters such as poly(ethylene terephthalate), poly(butylene terephthalte), poly(ethylene naphthalate) and poly(trimethylene naphthalate), and polyamides such as poly(ε-caproamide) (NYLON-6) and poly(hexamethylene adipamide)(NYLON-6,6). The polymers that may be included in the composition of the present invention with the flame retardant PTT containing co-polymer do not exceed 25 wt. %, or 15 wt. %, or 10 wt. %, or 5 wt. % of the composition. In an embodiment of the composition of the invention, the flame retardant PTT containing co-polymer may be present in the composition in a weight ratio to other polymers of at least 3:1, or at least 4:1, or at least 5:1, or at least 6:1. In an embodiment, no other polymer is present in the flame retardant PTT containing co-polymer composition other than the PTT containing co-polymer itself.

The flame retardant PTT co-polymer composition may have an intrinsic viscosity of at least 0.7 dl/g, or at least 0.8 dl/g, or at least 0.9 dl/g. In an embodiment, the flame retardant PTT co-polymer composition of the present invention may have an intrinsic viscosity of from 0.7 to 1.4 dl/g. Preferably, the composition of the invention has an intrinsic viscosity of from 0.8 to 1.2 dl/g. In accordance with the present invention, intrinsic viscosity is measured by dissolving a polymer in a solvent of phenol and 1,1,2,2-tetrachloroethane (60 parts phenol, by volume, 40 parts 1,1,2,2-tetrachloroethane, by volume) and measuring at 30° C. the intrinsic viscosity of the dissolved polymer on a relative viscometer, preferably Model No. Y501B available from Viscotek Company.

The flame retardant PTT co-polymer composition of the invention may have a tensile strength of at least 45 MPa, or at least 50 MPa, or at least 55 MPa, or at least 57 MPa, or at least 59 MPa, or at least 61 MPa. In accordance with the present invention the tensile strength of the PTT co-polymer composition of the invention may be measured according to ASTM Method D 638-02.

The flame retardant PTT co-polymer composition of the invention may contain dispersed therein minor amounts of a flame retardant component that does not have a melting point equal to or below 280° C., which is defined for purposes of the present invention as a “non-fusible flame retardant component”. The non-fusible flame retardant component, if present, does not have a melting point equal to or below 280° C., although the non-fusible flame retardant component may, but does not necessarily, have a melting point above 280° C. since the non-fusible flame retardant component may decompose rather than melt at temperatures above 280° C. Such non-fusible flame retardants may include: phosphinate metal salts of the formula (III) that do not melt at or below a temperature of 280° C.

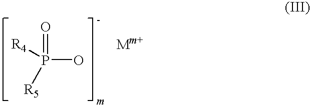

where R₄ and R₅ may be identical or different, and are C₁-C₁₈ alkyl, linear or branched, and/or aryl, M is Mg, Ca, Al, Sb, Ge, Ti, Fe, Zr, Ce, Bi, Sr, Mn, Li, Na, or K, and m is from 1 to 4; other phosphorous containing compounds that are non-fusible at a temperature of equal to or below 280° C., including inorganic phosphorous compounds such as red phosphorous; monomeric organic phosphorous compounds; orthophosphoric esters or condensates thereof; phosphoric ester amides; phosphonitrilic compounds; phosphine oxides (e.g. triphenylphosphine oxides); metal salts of phosphoric and phosphonic acids; diphosphinic salts; nitrogen containing compounds such as benzoguanamine compounds, ammonium polyphosphate, and melamine compounds such as melamine borate, melamine oxalate, melamine phosphate, melamine pyrophosphate, polymeric melamine phosphate, and melamine cyanurate; and polyhalogenated hydrocarbons.

If present, the non-fusible flame retardant component in the composition is present as a minor component of the flame retardant PTT co-polymer composition. The non-fusible flame retardant component may comprise from 0 wt. % to 5 wt. %, or from 0 wt. % to 2.5 wt. %, or from 0 wt. % to 1 wt. % of the flame retardant PTT co-polymer composition.

If present, the non-fusible flame retardant component in the composition may be particulate. The particle size of the non-fusible flame retardant component of the composition of the invention may range up to a mean particle size of 150 μm. In an embodiment, the mean particle size of the non-fusible flame retardant component is at most 10 μm, or the non-fusible flame retardant may contain nanoparticles and may have a mean particle size of at most 1 μM. Smaller mean particle size of the non-fusible flame retardant in the composition provides at least two benefits in the composition: 1) more homogeneous dispersion of the particulate flame retardant in the composition; and 2) reduced breakage induced in fibers melt spun from the composition as a result of large particulates in the melted composition.

In an embodiment, the flame retardant PTT co-polymer composition of the present invention may contain dispersed therein minor amounts of a flame retardant component that has a melting point equal to or below 280° C., which is defined for purposes of the present invention as a “fusible flame retardant component”. The fusible flame retardant component may be at least one flame retardant fusible phosphinate metal salt having a melting point of equal to or below 280° C., or below 270° C., or below 250° C., or below 230° C., or below 200° C., or below 180° C.

The flame retardant fusible phosphinate metal salt(s) may be any phosphinate metal salt having the structure shown in formula (IV) and having a melting point equal to or below 280° C., or below 270° C., or below 250° C., or below 230° C., or below 200° C., or below 180° C.

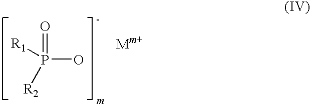

In formula (IV), R₁ and R₂ may be identical or different, and are C₁-C₁₈ alkyl, linear or branched, and/or aryl, M is Mg, Ca, Al, Sb, Ge, Ti, Fe, Zr, Ce, Bi, Sr, Mn, Li, Na, or K, and m is from 1 to 4. The flame retardant fusible phosphinate metal salt must have a melting point equal to or below 280° C., or below 270° C., or below 250° C., or below 230° C., or below 200° C., or below 180° C. so that it may be melted and dispersed in the PTT co-polymer at a temperature that will not substantially degrade the co-polymer.

In a preferred embodiment, the flame retardant fusible phosphinate metal salt is a zinc phosphinate having a melting point equal to or below 280° C., or below 270° C., or below 250° C., or below 230° C., or below 200° C., or below 180° C. and having the structure of formula (IV) where R₁ and R₂ are identical or different and are hydrogen, C₁-C₁₈ alkyl, linear or branched, and/or aryl, M is zinc, and m is 2. In one embodiment the zinc phosphinate has a melting point of equal to or below 280° C., or below 270° C., or below 250° C., or below 230° C., or below 200° C., or below 180° C. and is of the formula (IV), where R₁ and R₂ are identical or different and are methyl, ethyl, isopropyl, n-propyl, t-butyl, n-butyl, or phenyl, M is zinc, and m is 2. In a preferred embodiment, the zinc phosphinate is selected from the group consisting of zinc diethylphosphinate, zinc dimethylphospinate, zinc methylethylphosphinate, zinc diphenylphosphinate, zinc ethylbutylphosphinate, and zinc dibutylphosphinate. In a most preferred embodiment, the zinc phosphinate is zinc diethylphosphinate.

If present, the fusible flame retardant component in the composition is present as a minor component of the flame retardant PTT co-polymer composition. The fusible flame retardant component may comprise from 0 wt. % to 5 wt. %, or from 0 wt. % to 2.5 wt. %, or from 0 wt. % to 1 wt. % of the flame retardant PTT co-polymer composition. In an embodiment, the flame retardant PTT co-polymer composition may contain minor amounts of both a fusible flame retardant component and a non-fusible flame retardant component. If both a fusible flame retardant component and a non-fusible flame retardant component are present in the flame retardant PTT co-polymer composition, the combined fusible and non-fusible flame retardant components may comprise up to 5 wt. %, or up to 2.5 wt. %, or up to 1 wt. % of the flame retardant PTT co-polymer composition.

In an embodiment of the invention, the flame retardant PTT co-polymer composition may be a resin. The resin may be useful for forming various materials from the flame retardant PTT co-polymer resin composition such as polymer moldings, films, fibers, and filaments.

In an embodiment of the composition of the invention, the flame retardant PTT co-polymer composition may be a polymer molding composition. The polymer molding composition may include a filler, a reinforcing material, and/or a modifying agent. In an embodiment of the invention, a polymer molding composition of the flame retardant PTT co-polymer may contain from 0 wt. % to 50 wt. % of a filler, and/or from 0 wt. % to 25 wt. % of a reinforcing agent, where the combined filler and reinforcing agent may be present in an amount of from 0 wt. % to 50 wt. % of the composition. The flame retardant PTT co-polymer molding composition may also contain from 0 wt. % to 40 wt. % of a modifying agent.

In an embodiment of the invention, the flame retardant PTT co-polymer composition may be film. A polymer film of the flame retardant PTT co-polymer may contain from 0 wt. % to 50 wt. % of a filler, and/or from 0 wt. % to 25 wt. % of a reinforcing agent, where the combined filler and reinforcing agent may be present in an amount of from 0 wt. % to 50 wt. % of the composition. The flame retardant PTT co-polymer film may also contain from 0 wt. % to 40 wt. % of a modifying agent.

In another embodiment of the invention the flame retardant PTT co-polymer composition may be a fiber or a filament. The flame retardant PTT co-polymer fiber or filament may contain at most 5 wt. % filler and at most 5 wt. % of a modifying agent. Fillers and/or modifying agents may negatively affect the melt spinning of the PTT co-polymer composition by inducing breakage in the melt spun composition, therefore, it may be desirable to limit these materials in the flame retardant PTT co-polymer fiber or filament composition. In an embodiment of the invention, the flame retardant PTT co-polymer fiber or filament composition contains at most 2.5 wt. % filler, preferably at most 1 wt. % filler. A preferred filler in the flame retardant PTT polymer fiber or filament composition of the invention is a delustering agent, preferably titanium dioxide.

“Filler” as the term is used herein is defined as “a particulate or fibrous material having no measurable flame retardant activity”. Filler is commonly used to provide stiffness to polymer compositions used in molding applications or as a delustering agent in polymer compositions used in films, filaments, and fibers. Examples of filler materials that may be included in the composition of the invention include fibrous materials such as glass fiber, asbestos fiber, carbon fiber, silica fiber, fibrous woolastonite, silica-alumina fiber, zirconia fiber, potassium titanate fiber, metal fibers, and organic fibers with melting points above 300° C. Other filler materials that be included in this embodiment of the composition of the invention include particulate or amorphous materials such as carbon black, white carbon, silicon carbide, silica, powder of quartz, glass beads, glass powder, milled fiber, silicates such as calcium silicate, aluminum silicate, clay, and diatomites, metal oxides such as iron oxide, titanium oxide, zinc oxide, and alumina, metal carbonates such as calcium carbonate and magnesium carbonate, metal sulfates such as calcium sulfate and barium sulfate, and metal powders. For delustering purposes when the polymer composition is to be used to produce a film, filament, or fiber, titanium dioxide is a preferred filler.

“Reinforcing agent” as the term is used herein, is defined as a material useful to provide structural strength and integrity to the flame retardant PTT co-polymer composition. Reinforcing agents may include polyamides, polycarbonates, polysulfones, polyesters, polyurethane elastomers, polystyrene, polyethylene, and polypropylene.

“Modifying agent”, as the term is used herein, is defined as a material useful to modify the physical, chemical, color, or electrical characteristics of the flame retardant PTT co-polymer composition, excluding the filler materials, reinforcing agents and fusible and non-fusible flame retardants discussed above. Modifying agents may include conventional antioxidants, lubricants, dyes and other colorants, UV absorbers, and antistatic agents.

In one aspect, the present invention is directed to a process for producing the PTT containing co-polymer of the present invention. In an embodiment, the composition may be produced by co-polymerizing a trimethylene terephthalate containing material and a phosphorous containing compound of formula (V)

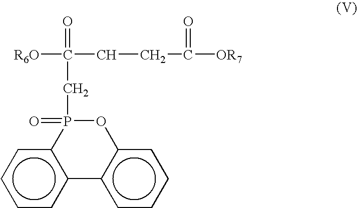

where R₆ and R₇ may be the same or different and are a hydrogen atom, an alkyl hydrocarbon group having from 1 to 5 carbons, or an alkyl alcohol group having from 1 to 5 carbons and one or more alcohol substituents—to form a flame retardant PTT containing polymer having an intrinsic viscosity of at least 0.7 dl/g and a tensile strength of at least 45 MPa.

In an embodiment, the trimethylene terephthalate containing material and the phosphorous containing compound of formula (IV) may be contacted at a temperature of from 230° C. to 280° C. and a pressure of from 0.01 kPa to 5 kPa (0.1 mbar to 50 mbar) to co-polymerize the trimethylene terephthalate containing material and the phosphorous containing compound. In an embodiment, the amounts of the trimetheylene terephthalate containing material and the phosphorous containing compound of formula (V) utilized in the co-polymerization may be selected to provide a mole ratio of trimethylene terephthalate to phosphorous containing compound of from 1:1 to 999:1.

In an embodiment, the flame retardant PTT containing polymer composition may be produced by 1) reacting terephthalic acid with 1,3-propanediol to form a trimethylene terephthalate containing material which may comprise trimethylene terephthalate and/or an oligomer thereof (the esterification step); and 2) co-polymerizing the trimethylene terephthalate containing material with a phosphorous containing compound of formula (V) (the co-polymerization step).

In the esterification step, the pressure may be adjusted to and maintained in a range of from 70 kPa to 550 kPa (0.7 bar to 5.5 bar) and the temperature may be adjusted to and maintained in the range of from 230° C. to 280° C., or from 240° C. to 270° C. In an embodiment of the process, the instantaneous concentration of unreacted 1,3-propanediol in the reaction mass in the esterification step may be kept low to minimize formation of dipropyleneglycol by regulation of the reactant feeds—e.g. 1,3-propanediol and terephthalic acid may be regulated such that they are added to the reaction mass in a molar ratio of 1.15:1 to 2.5:1 to minimize formation of dipropylene glycol- and the reaction pressure may be kept low, e.g. less than 300 kPa absolute (3 bar absolute), to remove excess unreacted 1,3-propanediol from the reaction medium in the reaction overhead gases.

In an embodiment, minor amounts of other compounds may be included in the esterification step that may be incorporated into the trimethylene terephthalate containing material. For example, compounds such as ethylene glycol, 1,4 butanediol, 1,4-butenediol, 1,4-cyclohexanedimethanol, oxalic acid, succinic acid, phthalic acid, 2,6-naphthalenedicarboxylic acid, 5-sodiumsulfoisophthalic acid, isophthalic acid, and/or adipic acid may be included in the esterification step. Such compounds may be included in amounts that they comprise, along with any other such compounds utilized in the co-polymerization step, at most 25 mol %, or at most 15 mol %, or at most 10 mol %, or at most 5 mol % of the final PTT containing co-polymer composition.

An esterification catalyst may be used to promote the esterification reaction. Esterification catalysts useful for promoting the esterification reaction include titanium and zirconium compounds, including titanium alkoxides and derivatives thereof such as tetra(2-ethylhexyl)titanate, tetrastearyl titanate, diisopropoxy-bis(acetylacetonato)titanium, tributyl monacetyltitanate, triisopropyl monoacetyltitanate; di-n-butoxy-bis(triethanolaminoato) titanium, tetrabenzoic acid titanate, and titanium tetrabutoxide; titanium complex salts such as alkali titanium oxalates and malonates, potassium hexafluorotitanate and titanium complexes with hydroxycarboxylic acids such as tartaric acid, citric acid, or lactic acid, catalysts such as titanium dioxide/silicon dioxide co-precipitate and hydrated alkaline-containing titanium dioxide; and the corresponding zirconium compounds. Catalysts of other metals, such as antimony, tin, and zinc, may also be used. A preferred catalyst for use in promoting the esterification reaction is titanium tetrabutoxide. The esterification catalyst may be provided to the esterification reaction mass in an amount effective to catalyze the esterification, and may be provided in an amount in the range of 5 to 250 ppm (metal), or in the range of 10 ppm to 100 ppm (metal), based on the weight of the final PTT containing co-polymer composition.

The esterification may be carried out in stages in a single or multiple vessels at one or more temperatures and/or pressures with one or more catalysts or catalyst amounts present in each stage. For example, a two-stage esterification step may include a first stage carried out in a first esterification vessel at or a little above atmospheric pressure in the presence of 5 to 50 ppm titanium catalyst and a second stage carried out in a second esterification vessel at or below atmospheric pressure with an additional 20 to 150 ppm of titanium catalyst added, where both stages are conducted at a temperature of from 230° C. to 280° C., or from 240° C. to 270° C. The first esterification stage may be conducted until a selected amount of terephthalic acid is consumed, for example, at least 85%, or at least 90%, or at least 95%, or from 85% to 95%. The second esterification stage may also be conducted until a selected amount of terephthalic acid is consumed, for example, at least 97%, or at least 98%, or at least 99%. In a continuous process, the esterification steps may be carried out in separate reaction vessels.

The conditions of the esterification may be selected to produce a low molecular weight oligomeric esterification product containing trimethylene terephthalate monomers. The oligomeric trimethylene terephthalate containing material may have an intrinsic viscosity of less than 0.2 dl/g, or from 0.05 to 0.15 dl/g (corresponding to a degree of polymerization of 3 to 10, e.g. the value of p of formula (I) above is from 3 to 10).

In the co-polymerization step, the trimethylene terephthalate containing material produced in the esterification step may be contacted and mixed with the phosphorous containing compound of formula (V) under conditions effective to induce co-polymerization of the trimethylene terephthalate containing material and the phosphorous containing compound. The co-polymerization step may comprise several steps, for example: a pre-polycondensation step in which the reaction mixture containing the trimethylene terephthalate containing material and the phosphorous containing compound of formula (V) may be processed under selected temperature and pressure conditions to produce a product having an intrinsic viscosity of from 0.15 to 0.4 dl/g (corresponding to a degree of polymerization of 10 to 30, e.g., the sum of the values of p of formula (I) and q of formula (II) is from 10 to 30); a melt polycondensation step in which the reaction mixture comprising the product of the pre-polycondensation step or alternatively, the trimethylene terephthalate containing material from the esterification step and the phosphorous containing compound of formula (V), may be processed under selected temperature and pressure conditions to produce a melt co-polymer product having an intrinsic viscosity of at least 0.25 dl/g or least 0.7 dl/g, or at least 0.8 dl/g, or at least 0.9 dl/g; and a solid state polymerization step in which the melt co-polymer may be solidified, optionally dried and annealed, heated, and charged to a solid state polymerization reactor for further polycondensation to raise the intrinsic viscosity of the co-polymer. The co-polymerization step may optionally contain fewer than the three steps specified above, for example, an all melt PTT co-polymer may be produced by omitting the solid state polymerization step, where the pre-polycondensation step and the melt polycondensation step produce a melt co-polymer having a intrinsic viscosity of at least 0.7 dl/g, or at least 0.8 dl/g, or at least 0.9 dl/g.

The phosphorous containing compound of formula (V) where R₆ and R₇ are both hydrogen atoms may be produced by reacting equimolar amounts of 9,10-dihydro-9-oxa-10-phosphaphenanthrene-10-oxide (62.4 wt. %), shown as formula (VI),

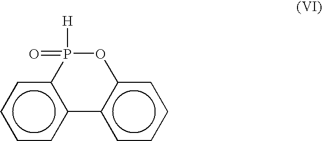

with itaconic acid (37.6 wt. %), shown as formula (VII),

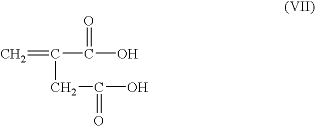

at a temperature of from 120° C. to 200° C. or from 140° C. to 180° C. for a period effective to convert at least a majority, or at least 75%, or at least 85%, or at least 90% of the reactants to the phosphorous compound of formula (V) where R₆ and R₇ are hydrogen atoms, which may be a period of at least 15 minutes, or at least 30 minutes, or at least 60 minutes, or at least 90 minutes. In an embodiment, the preparation of the phosphorous compound of formula (V) may be conducted under an inert atmosphere, for example under a nitrogen atmosphere. Where R₆ and/or R₇ of the phosphorous compound of formula (V) are an alkyl hydrocarbon group having from 1 to 5 carbons, the phosphorous compound of formula (V) having R₆ and R₇ hydrogen atoms may be reacted with an alkyl alcohol to produce the desired phosphorous compound, where the molar ratio of the alkyl alcohol to the phosphorous compound may range from 0.5:1 to 2.5:1, or from 1:1 to 2:1. Where R₆ and/or R₇ of the phosphorous compound of formula (V) are an alkyl alcohol group having 1 to 5 carbon atoms and having one or more alcohol substituents, the phosphorous compound of formula (V) having R₆ and R₇ hydrogen atoms may be reacted with an alkyl diol or polyol to produce the desired phosphorous compound, where the molar ratio of the alkyl diol or polyol to the phosphorous compound may range from 0.5:1 to 2.5:1, or from 1:1 to 2:1. The phosphorous compound having R₆ and R₇ hydrogen atoms and the alkyl alcohol, diol, or polyol may be reacted at a temperature of from 75° C. to 200° C., or from 100° C. to 150° C. for a period of time effective to replace the R₆ and/or R₇ hydrogen atom with the alkyl group, or alkyl alcohol, diol, or polyol group. In an alternative embodiment, the alkyl alcohol, diol, or polyol may be added to the reaction mixture of the 9,10-dihydro-9-oxa-10-phosphaphenanthrene-10-oxide and itaconic acid in an amount from equimolar to two times the respective molar amounts of each of the other reactants.

In an embodiment of the process, minor amounts of other compounds may be included in the co-polymerization step that may be incorporated into the PTT co-polymer product. For example, compounds such as ethylene glycol, 1,4 butanediol, 1,4-butenediol, 1,4-cyclohexanedimethanol, oxalic acid, succinic acid, phthalic acid, 2,6-naphthalenedicarboxylic acid, 5-sodiumsulfoisophthalic acid, isophthalic acid, and/or adipic acid may be included in the co-polymerization step. Such compounds may be included in amounts that they comprise, in combination with any such compounds utilized in the esterification step, at most 25 mol %, or at most 15 mol %, or at most 10 mol %, or at most 5 mol % of the final PTT co-polymer composition.

The relative amounts of the 1,3-propanediol and terephthalic acid components used to form the trimethylene terephthalate containing material in the esterification step and the phosphorous containing compound of formula (V) in the co-polymerization reaction step are selected so that trimethylene terephthalate co-monomer in the esterification product may be present in the mixture in an amount of at least 50 mol %, or at least 70 mol %, or at least 90 mol %, or at least 95 mol %, or at least 99 mol % of the total moles of reactants in the copolymerization step, and the phosphorous containing compound may be present in the co-polymerization reaction mixture in an amount greater than 0 mol % up to 50 mol % of the total moles of reactants in the copolymerization step, or up to 30 mol %, or up to 10 mol %, or up to 5 mol %, or up to 1 mol % of the total moles of reactants in the copolymerization step. In an embodiment trimethylene terephthalate co-monomer may be present in the mixture for co-polymerization an amount of from 50 mol % to 99.9 mol %, or from 70 mol % to 99 mol % of the total moles of reactants in the copolymerization step and the phosphorous containing compound may be present in the mixture in an amount of from greater than 0 mol % to 50 mol %, or from 0.1 mol % to 30 mol %, or from 0.5 mol % to 10 mol % of the total moles of reactants in the copolymerization step. Alternatively, trimethylene terephthalate co-monomer may be present in the mixture for copolymerization in an amount of at least 20 wt. %, or at least 25 wt. %, or at least 30 wt. % up to 99.9 wt. %, or up to 99.5 wt. %, or up to 99 wt. % of the total weight of the reactants, and the phosphorous compound of formula (V) may be present in the mixture in an amount of at least 0.1 wt. %, or at least 0.3 wt. %, or at least 1 wt. %, or at least 2 wt %, up to 80 wt. %, or up to 75 wt. %, or up to 50 wt. % of the total weight of the reactants.

In an embodiment, it may be preferable to maximize the poly(trimethylene terephthalate) character of the co-polymer by maximizing the trimethylene terephthalate co-monomer of formula (I) content and minimizing the phosphorous containing component of formula (II) content in the co-polymer. This may be useful to provide a polymer having characteristics similar to a poly(trimethylene terephthalate) homopolymer yet having improved flame retardance relative to a PTT homopolymer. In this embodiment, the minimum amount of the phosphorous containing compound of formula (V) required to provide a desired degree of flame retardancy is included in the co-polymerization step. For example, at most 5 mol %, or at most 4 mol %, or at most 3 mol %, or at most 2 mol %, or from 0.25 mol % to 3 mol %, or from 0.5 mol % to 2 mol % of the phosphorous containing compound of formula (V), relative to the total moles of reactants, may be included in the mixture for co-polymerization to provide a PTT co-polymer having flame retardancy with a minimal amount of the phosphorous containing component of formula (II) monomer. Alternatively, at most 5 wt. %, or at most 4 wt. %, or at most 3 wt. %, or from 0.5 wt. % to 4 wt. %, or from 1 wt. % to 3 wt. % of the phosphorous containing compound of formula (V), based on the total weight of the reactants, may be included in the mixture for co-polymerization to provide a PTT co-polymer having flame retardancy with a minimal amount of the phosphorous containing component monomer.

The co-polymerization may comprise an optional pre-polycondensation step which is useful to obtain a high intrinsic viscosity PTT melt co-polymer, particularly in the absence of subsequent a solid state polymerization step. In the pre-polycondensation step, the trimethylene terephthalate containing material from the esterification step and the phosphorous containing compound of formula (V) may be mixed and reacted where the reaction pressure may be reduced to less than 20 kPa (200 mbar), or less than 10 kPa (100 mbar), or from 0.2 kPa to 20 kPa (2 mbar to 200 mbar), or from 0.5 kPa to 10 kPa (5 mbar to 100 mbar) and the temperature may be from 230° C. to 280° C., or from 240° C. to 275° C., or from 250° C. to 270° C. The pre-polycondensation step of the co-polymerization may be carried out at two or more vacuum stages, where each stage may have a successively lower pressure. For example, a two-stage pre-polycondensation may be effected in which the phosphorous containing compound of formula (V) and the trimethylene terephthalate containing material from the esterification step are mixed at an initial pressure of from 5 kPa to 20 kPa (50 mbar to 200 mbar) and then mixed at a second pressure of from 0.2 kPa to 2 kPa (2 mbar to 20 mbar) while being held at a temperature of from 230° C. to 280° C., preferably from 250° C. to 270° C. The pre-polycondensation step may be conducted until the pre-polycondensation reaction product has the desired intrinsic viscosity, which may be for at least 10 minutes, or at least 25 minutes, or at least 30 minutes, and up to 4 hours, or up to 3 hours, or up to 2 hours, or from 10 minutes to 4 hours, or from 25 minutes to 3 hours, or from 30 minutes to 2 hours.

The pre-polycondensation step of the co-polymerization may be carried out in the presence of a pre-polycondensation catalyst. The pre-polycondensation catalyst is preferably a titanium or zirconium catalyst selected from the titanium and zirconium catalysts discussed above in relation to the esterification step due to the high activity of these metals. The pre-polycondensation catalyst may be provided to the pre-polycondensation reaction mass in an amount effective to catalyze the reaction, and may be provided in an amount in the range of 5 to 250 ppm (metal), or in the range of 10 ppm to 100 ppm (metal), based on the weight of the final co-polymer. In an embodiment, at least a portion or all of the pre-polycondensation catalyst may be the catalyst used in the esterification reaction and included in the pre-polycondensation reaction in the esterification product mixture.

The co-polymerization includes a polycondensation step which may produce a PTT melt co-polymer having an intrinsic viscosity of at least 0.4 dl/g or at least 0.7 dl/g, or at least 0.8 dl/g, or at least 0.9 dl/g. In the polycondensation step, the pre-polycondensation step product, or alternatively the trimethylene terephthalate containing material from the esterification step and the phosphorous containing compound of formula (V), may be mixed and reacted where the reaction pressure may be reduced to 0.02 kPa to 0.25 kPa (0.2 mbar to 2.5 mbar) and the temperature may be from 240° C. to 275° C., or from 250° C. to 270° C. The polycondensation step may be carried out for a period of time effective to provide a PTT melt co-polymer having the desired intrinsic viscosity, which is at least 0.4 dl/g where a subsequent solid state polymerization step is effected or at least 0.7 dl/g in an all melt process without a subsequent solid state polymerization step. In general, the polycondensation step may require from 1 to 6 hours, with shorter reaction times preferred to minimize the formation of color bodies.

The polycondensation step of the co-polymerization includes a polycondensation catalyst, preferably a titanium or zirconium compound, such as those discussed above in relation to the esterification step because of the high activity of these metals. A preferred polycondensation catalyst is titanium butoxide. The polycondensation catalyst may be provided to the polycondensation reaction mass in an amount effective to catalyze the reaction, and may be provided in an amount in the range of 5 to 250 ppm (metal), or in the range of 10 ppm to 100 ppm (metal), based on the weight of the final co-polymer. In an embodiment, at least a portion or all of the polycondensation catalyst may be the catalyst used in the pre-polycondensation reaction and/or the esterification reaction and included in the polycondensation reaction in the pre-polycondensation product mixture and/or the esterification product mixture.

The polycondensation step is most suitably carried out in a high surface area generation reactor capable of large vapor mass transfer, such as a cage-type, basket, perforated disk, disk ring, or twin screw reactor. Optimum results are achievable in the process from the use of a cage-type reactor or a disk ring reactor, which promote the continuous formation of large film surfaces in the reaction product and facilitate evaporation of excess 1,3-propanediol and polymerization by-products.

The polycondensation step may optionally include the addition to the reaction mixture of stabilizers, coloring agents, fillers, and other additives for polymer property modification. Specific additives include coloring agents such as cobalt acetate or organic dyes; stabilizers such as hindered phenols; branching agents such as polyfunctional carboxylic acids, polyfunctional acid anhydrides, and polyfunctional alcohols; and particulate fillers including delustering agents such as titanium dioxide, fibrous materials such as glass fiber, asbestos fiber, carbon fiber, silica fiber, fibrous woolastonite, silica-alumina fiber, zirconia fiber, potassium titanate fiber, metal fibers, and organic fibers with melting points above 300° C., and particulate or amorphous materials such as carbon black, white carbon, silicon carbide, silica, powder of quartz, glass beads, glass powder, milled fiber, silicates such as calcium silicate, aluminum silicate, clay, and diatomites, metal oxides such as iron oxide, zinc oxide, and alumina, metal carbonates such as calcium carbonate and magnesium carbonate, metal sulfates such as calcium sulfate and barium sulfate, and metal powders In the event the flame retardant PTT containing co-polymer is to be used to produce a fiber or filament, to limit particulate induced breakage of a fiber spun from the polycondensed PTT co-polymer, particulate additives, such as fillers, may be included in the polycondensation step in a limited amount of from 0 wt. % to 5 wt. % of the PTT co-polymer composition, more preferably from 0 wt. % to 3 wt. % of the PTT co-polymer composition.

Optionally, in an “all-melt” process, upon completion of the polycondensation (i.e. upon achieving the desired intrinsic viscosity in the polycondensation mixture), the polycondensation product may be cooled to produce the flame retardant PTT co-polymer. The polycondensation product may be cooled, solidified and pelletized using a strand pelletizer, an underwater pelletizer, or a drop forming device.

The co-polymerization may comprise an optional solid state polymerization step which is useful to obtain a high intrinsic viscosity PTT co-polymer, particularly in the absence of pre-polycondensation step. The polycondensation product may be cooled, solidified, and pelletized using a strand pelletizer, and underwater pelletizer, or a drop forming device. The resulting PTT co-polymer pellets may then be fed into a crystallizer/preheater in which the pellets are rapidly preheated to a solid state reaction temperature which is between 150° C. and up to 1° C. below the melting temperature of the PTT co-polymer. The PTT co-polymer pellets may be pre-heated for a period of time typically of from 5 to 60 minutes or from 10 to 30 minutes.

The crystallizer/preheater may be a fluid bed or an agitated heat exchanger. Suitable types of fluid beds include standard (stationary) fluid beds, vibrating fluid beds, and pulsating fluid beds. Multiple heating zones may be used to narrow the residence time distribution of the PTT co-polymer pellets as well as to improve energy efficiency. In a single-zone crystallizer/pre-heater, the temperature of the direct heat transfer medium (i.e. hot nitrogen or hot air in a fluid bed) or the heat transfer surface (of an agitated heat exchanger) is at least as high as the intended solid state reactor temperature. Thus the PTT co-polymer is exposed to the reaction temperature as soon as it is charged into the single-zone crystallizer/preheater. In a multiple-zone crystallizer/preheater, the heat transfer medium or heat transfer surface temperature of the first zone may be lower or no lower than the solid state reactor temperature. Thus the PTT co-polymer may be exposed to the solid state reaction temperature in the first or later zones of the multiple-zone crystallizer/preheater.

The preheated pellets may then be discharged from the crystallizer/preheater into a solid state reactor. Inside the solid state reactor, solid state polycondensation takes place as the PTT co-polymer pellets move downward by gravitational force in contact with a stream of inert gas, typically nitrogen, which flows upwardly to sweep away reaction by-products such as 1,3-propanediol, water, allyl alcohol, acrolein, and cyclic dimer. The nitrogen flow rate may be from 0.11 to 0.45 kg/min per kg of PTT co-polymer (0.25 to 1.0 pound/min per pound of PTT co-polymer). The nitrogen may be heated or unheated before entering the reactor. The exhaust nitrogen may be purified and recycled after exiting the reactor.

The PTT co-polymer pellets may be discharged as solid-stated product from the bottom of the solid state reactor, after having acquired the desired intrinsic viscosity. The solid-stated product may be cooled to below 65° C. in a product cooler, which may be a fluid bed or an agitated heat exchanger. The solid-stated PTT co-polymer product may be cooled in an atmosphere of nitrogen or air.

In an embodiment in which the co-polymerization includes a solid-state polymerization step, the esterfication and copolymerization steps may be conducted so that a pre-polycondensation step is not required. The esterification step may be conducted as described above, where the esterification step is conducted under a super-atmospheric pressure of from 205 kPa to 550 kPa absolute (2.05 bar to 5.5 bar absolute) in the absence of an esterification catalyst to produce the trimethylene terephthalate containing material. The co-polymerization may be conducted utilizing a polycondensation step and a solid-state polymerization step, where the polycondensation step includes the addition of from 10 to 400 ppm of a polycondensation catalyst based on the weight of the co-polymer, as described above, under reaction conditions for polycondensation as described above, except that the polycondensate product needs only have an intrinsic viscosity of at least 0.25 dl/g. The polycondensate PTT co-polymer product may then be solid-state polymerized as described above to produce a PTT co-polymer having an intrinsic viscosity of at least 0.7 dl/g. or at least 0.8 dl/g, or at least 0.9 dl/g.

In a preferred embodiment, the co-polymerization does not require a solid state polymerization step, and a PTT co-polymer having an intrinsic viscosity sufficient to be utilized in a variety of applications (e.g. at least 0.7 dl/g, or at least 0.8 dl/g, or at least 0.9 dl/g) may be produced using an all-melt process in which the esterification, pre-polycondensation step and the polycondensation step, as described above, are sufficient to produce the PTT co-polymer with the required intrinsic viscosity.

In an alternative embodiment, dimethylterephthalate (DMT) may be substituted for terephthalic acid in the esterification step (which becomes a transesterification step upon the substitution). The process of producing a PTT co-polymer using DMT in place of terephthalic acid in a transesterification step may be performed in a similar manner as the process utilizing terephthalic acid in the esterification step as described above, except that DMT is substituted for terephthalic acid. The transesterification generates an alcohol, specifically methanol, which is distilled off as a byproduct under the transesterification reaction conditions.

In another embodiment, the flame retardant PTT co-polymer composition may be produced by forming the phosphorous containing compound of formula (V) from 9,10-dihydro-9-oxa-10-phosphaphenanthrene-10-oxide, itaconic acid, and, optionally selected alkyl alcohols, alkyl diols, and/or alkyl polyols as described above, and including the phosphorous containing compound of formula (V) in the esterification or transesterification step described above, followed by the co-polymerization step as described above. Optionally, in this embodiment, addition of the phosphorous containing compound of formula (V) may be excluded from the co-polymerization step provided sufficient amounts of the phosphorous compound are added in the esterification or transesterification step to provide the PTT co-polymer composition with sufficient flame retardancy. Sufficient amounts of the phosphorous compound required in the process to provide an effective degree of flame retardancy to the PTT co-polymer composition are described above. The amounts of 1,3-propanediol, a compound selected from the group consisting of terephthalic acid, dimethylterephthalate, and mixtures thereof, and the phosphorous containing compound are also selected to provide the flame retardant PTT co-polymer composition with from 50 mol % to 99.9 mol % of the trimethylene terephthalate monomer of formula (I) in the PTT co-polymer.

In another embodiment, 9,10-dihydro-9-oxa-10-phosphaphenanthrene-10-oxide, itaconic acid, and, optionally selected alkyl alcohols, alkyl diols, and/or alkyl polyols as described above, may be directly included in the esterification or transesterification step of 1,3-propanediol and terephthalic acid or dimethylterephthalate as described above. In this embodiment, a phosphorous containing compound of formula (V) need not be added in either the esterification or transesterification step or in the copolymerization step, however, optionally, a phosphorous containing compound of formula (V) may be added in either of these steps. The amounts of 1,3-propanediol and terephthalic acid or dimethylterephthalate in the esterification mixture relative to each other are described above in the description of the esterification step. The 9,10-dihydro-9-oxa-10-phosphaphenanthrene-10-oxide and itaconic acid may be added in equimolar amounts relative to each other in the esterification reaction. The amounts of 9,10-dihydro-9-oxa-10-phosphaphenanthrene-10-oxide and itaconic acid relative to 1,3-propanediol and terephthalic acid or dimethylterephthalate in the esterification reaction mixture may be selected to provide a final PTT co-polymer composition comprising at least 50 mol %, or at least 70 mol %, or at least 90 mol %, or at least 95 mol %, or at least 99 mol % trimethylene terephthalate monomer of formula (I) above.

In an embodiment of the process of the present invention, a supplementary polymer may be mixed with the flame retardant PTT co-polymer to form a flame retardant PTT containing co-polymer composition. The flame retardant PTT co-polymer and supplementary polymer may be mixed at a temperature of from 180° C. to 280° C. where the temperature is selected so that flame retardant PTT co-polymer and the supplementary polymer each have a melting point below the selected temperature. The supplementary polymer may be mixed with the flame retardant PTT co-polymer in an amount of up to 25 wt. %, or up to 15 wt. %, or up to 10 wt. %, or up to 5 wt. % of the mixture of the flame retardant PTT co-polymer and supplementary polymer. In one embodiment, the supplementary polymer is selected from the group consisting of polyamides and polyesters. The supplementary polymer may be NYLON-6, NYLON-6,6, poly(ethylene terephthalate), poly(butylene terephthalate), poly(ethylene naphthalate), poly(trimethylene naphthalate), or mixtures thereof. In another embodiment, the supplementary polymer may be a polysulfone.

In an embodiment of the process of the present invention, a non-fusible flame retardant that does not have a melting point below 280° C. may be incorporated in the flame retardant PTT containing co-polymer to provide additional flame retardancy, if desired. Such non-fusible flame retardants may include: phosphinate metal salts of the formula (III) above that do not melt or decompose at or below a temperature of 280° C.; other phosphorous containing compounds that are non-fusible at a temperature of equal to or below 280° C., including inorganic phosphorous compounds such as red phosphorous; monomeric organic phosphorous compounds; orthophosphoric esters or condensates thereof; phosphoric ester amides; phosphonitrilic compounds; phosphine oxides (e.g. triphenylphosphine oxides); metal salts of phosphoric and phosphonic acids; diphosphinic salts; nitrogen containing compounds such as benzoguanamine compounds, ammonium polyphosphate, and melamine compounds such as melamine borate, melamine oxalate, melamine phosphate, melamine pyrophosphate, polymeric melamine phosphate, and melamine cyanurate; and polyhalogenated hydrocarbons. In an embodiment of the process of the present invention, a non-fusible flame retardant may be incorporated in the flame retardant PTT containing co-polymer composition by heating the co-polymer composition to a temperature above the melting point of the co-polymer composition but below 280° C. and mixing the non-fusible flame retardant in the molten co-polymer.

If a non-fusible flame retardant is mixed in the flame retardant PTT containing co-polymer composition, the non-fusible flame retardant component in the composition may be added in a minor amount such that the non-fusible flame retardant component may comprise from 0 wt. % to 5 wt. %, or from 0 wt. % to 2.5 wt. %, or from 0 wt. % to 1 wt. % of the total weight of the flame retardant PTT containing composition (including any other polymers, fillers, reinforcing agents, modifying agents, or fusible flame retardant components mixed with the flame retardant PTT co-polymer) and the non-fusible flame retardant. Further, if a non-fusible flame retardant is mixed in the flame retardant PTT containing co-polymer composition, the non-fusible flame retardant component mixed in the composition may be particulate. The particle size of the non-fusible flame retardant component of the composition of the invention may range up to a mean particle size of 150 μm. In an embodiment, the mean particle size of the non-fusible flame retardant component may be at most 10 μm, or the non-fusible flame retardant may contain nanoparticles and may have a mean particle size of at most 1 μm.

In an embodiment of the process of the present invention, a fusible flame retardant that has a melting point equal to or less than 280° C. may be incorporated into the flame retardant PTT containing co-polymer to provide additional flame retardancy, if desired. Such fusible flame retardants are described above. The fusible flame retardant may be incorporated into the flame retardant PTT co-polymer composition by heating the fusible flame retardant and the flame retardant PTT co-polymer, separately or together, to a temperature above the melting points of the fusible flame retardant and the flame retardant PTT co-polymer, then mixing the molten fusible flame retardant and molten flame retardant PTT co-polymer to disperse the fusible flame retardant in the PTT co-copolymer.

If a fusible flame retardant is mixed in the flame retardant PTT co-polymer composition, the fusible flame retardant component may be added in a minor amount such that the fusible flame retardant may comprise from 0 wt. % to 5 wt. %, or from 0.1 wt. % to 2.5 wt. %, or from 0.1 wt. % to 1 wt. % of the total weight of the flame retardant PTT co-polymer composition (including any other polymers, fillers, reinforcing agents, modifying agents, and non-fusible flame retardant components) mixed with the flame retardant PTT co-polymer) and the fusible flame retardant.

In an embodiment of the process of the present invention, a filler may be mixed into the flame retardant PTT containing co-polymer composition. “Filler” as the term is used herein is defined as “a particulate or fibrous material having no measurable flame retardant activity”. Examples of filler materials that may be utilized in the process of the present invention include fibrous materials such as glass fiber, asbestos fiber, carbon fiber, silica fiber, fibrous woolastonite, silica-alumina fiber, zirconia fiber, potassium titanate fiber, metal fibers, and organic fibers with melting points above 300° C., carbon black, white carbon, silicon carbide, silica, powder of quartz, glass beads, glass powder, milled fiber, silicates such as calcium silicate, aluminum silicate, clay, and diatomites, metal oxides such as iron oxide, titanium oxide, zinc oxide, and alumina, metal carbonates such as calcium carbonate and magnesium carbonate, metal sulfates such as calcium sulfate and barium sulfate, and metal powders. For delustering purposes when the polymer composition is to be used to produce a film, filament, or fiber, titanium dioxide is a preferred filler. In an embodiment of the process of the present invention, a filler may be incorporated in the flame retardant PTT containing co-polymer composition by heating the co-polymer composition to a temperature above the melting point of the co-polymer composition but below 280° C. and mixing the filler in the molten co-polymer. Filler may be mixed in the flame retardant PTT containing composition such that the filler comprises from 0 wt. % to 50 wt. %, or from 0 wt. % to 25 wt. % or from 1 wt. % to 10 wt. % of the total weight of the flame retardant PTT containing co-polymer composition (including any other polymers, flame retardants, or modifying agents mixed with the flame retardant PTT co-polymer) and the filler.

In an embodiment of the process of the present invention, a modifying agent may be mixed into the flame retardant PTT containing co-polymer composition. “Modifying agent”, as the term is used herein, is defined as a material useful to modify the physical, chemical, color, or electrical characteristics of the flame retardant PTT co-polymer composition, excluding filler materials and reinforcing agents, as defined above. Modifying agents may include conventional antioxidants, lubricants, dyes and other colorants, UV absorbers, and antistatic agents. In an embodiment of the process of the present invention, a modifying agent may be incorporated in the flame retardant PTT containing co-polymer composition by heating the co-polymer composition to a temperature above the melting point of the co-polymer composition but below 280° C. and mixing the modifying agent in the molten co-polymer. The modifying agent may be mixed in the flame retardant PTT containing co-polymer composition such that the modifying agent comprises from 0 wt. % to 25 wt. %, or from 0 wt. % to 10 wt. % or from 1 wt. % to 5 wt. % of the total weight of the flame retardant PTT containing co-polymer composition (including any other polymers, flame retardants, or filler mixed with the flame retardant PTT co-polymer) and the modifying agent.

In an embodiment of the process of the invention, the flame retardant PTT co-polymer is formed into a molded composition. The flame retardant PTT co-polymer may be formed into a molded composition in accordance with conventional processes for forming polymer molded compositions including injection molding, foam injection molding, blow molding, internal gas pressure molding and compression molding. Prior to or during the molding process from 0 wt. % to 50 wt. % of a filler, as defined above, may be added to the flame retardant PTT co-polymer, and/or from 0 wt. % to 25 wt. % of a reinforcing agent, as defined above, may be added to the flame retardant PTT co-polymer, and/or from 0 wt. % to 40 wt. % of a modifying agent, as defined above, may be added to the flame retardant PTT co-polymer—where the filler, reinforcing agent, and/or modifying agent are preferably added to the flame retardant PTT co-polymer when the co-polymer is in a molten state. If both a filler and a reinforcing agent are added to the flame retardant PTT co-polymer in the process of forming a molded composition, it is preferred that the combined filler and reinforcing agent do not exceed 50 wt. % of the molded composition.

In an embodiment of the process of the invention, the flame retardant PTT co-polymer is formed into a film. The flame retardant PTT co-polymer may be formed into a film in accordance with conventional processes for forming polymer films including film casting, lamination, or coating. Prior to or during the film-making process from 0 wt. % to 50 wt. % of a filler, as defined above, may be added to the flame retardant PTT co-polymer, and/or from 0 wt. % to 25 wt. % of a reinforcing agent, as defined above, may be added to the flame retardant PTT co-polymer, and/or from 0 wt. % to 40 wt. % of a modifying agent, as defined above, may be add to the flame retardant PTT co-polymer—where the filler, reinforcing agent, and/or modifying agent are preferably added to the flame retardant PTT co-polymer when the co-polymer is in a molten state. If both a filler and a reinforcing agent are added to the flame retardant PTT co-polymer in the process of forming a film, it is preferred that the combined filler and reinforcing agent do not exceed 50 wt. % of the film.

In an embodiment of the process of the invention, the flame retardant PTT co-polymer is formed into melt blown fiber or filament. The flame retardant PTT co-polymer may be formed into melt blown fiber or filament in accordance with conventional processes for forming melt blown polymer fibers and filaments. Prior to or during the fiber or filament-making process from 0 wt. % to 50 wt. % of a filler, as defined above, may be added to the flame retardant PTT co-polymer, and/or from 0 wt. % to 25 wt. % of a reinforcing agent, as defined above, may be added to the flame retardant PTT co-polymer, and/or from 0 wt. % to 40 wt. % of a modifying agent, as defined above, may be add to the flame retardant PTT co-polymer—where the filler, reinforcing agent, and/or modifying agent are preferably added to the flame retardant PTT co-polymer when the co-polymer is in a molten state. If both a filler and a reinforcing agent are added to the flame retardant PTT co-polymer in the process of forming a filament, it is preferred that the combined filler and reinforcing agent do not exceed 50 wt. % of the filament. In one embodiment of the invention, filler such as titanium dioxide is particularly useful as a delustering agent in the formation of flame retardant PTT co-polymer fibers or filaments.

In another embodiment of the process of the invention, the flame retardant PTT co-polymer may be spun into a fiber or filament. The flame retardant PTT co-polymer may be formed into a fiber or filament in accordance with conventional processes for spinning fibers or filaments from co-polymers, for example by melt spinning processes. In a preferred embodiment for spinning a fiber or filament, at most 5 wt. %, or at most 2.5 wt. %, or at most 1 wt. % of a filler, as defined above, may be mixed with the flame retardant PTT co-polymer prior to spinning the fiber or filament. In one embodiment of the invention, filler such as titanium dioxide is particularly useful as a delustering agent in the formation of flame retardant PTT polymer spun fibers or filaments. In another embodiment, it may be preferred to minimize particulates such as fillers mixed with the flame retardant PTT co-polymer prior to spinning the polymer into a fiber or filament to limit or eliminate breakage of the fiber or filament during the melt spinning process. In another embodiment, from 0 wt. % to 5 wt. % of a reinforcing agent, as defined above, and/or from 0 wt. % to 5 wt. % of a modifying agent, as defined above, may be added to the flame retardant PTT co-polymer prior to spinning the polymer into a fiber or filament.

### Example 1

Three flame retardant PTT co-polymer samples of the present invention were made in accordance with a process of the present invention, where the first sample was made to contain 0.75 wt. % of a flame retardant co-polymer, the second to contain 1.5 wt. % of the same flame retardant co-polymer, and the third to contain 3.0 wt. % of the same flame retardant co-polymer. A control PTT polymer sample was also made for tensile strength comparison with the three samples of the present invention.

Each of the three flame retardant PTT co-polymer composition samples were made as follows. For each sample, terephthalic acid and 1,3-propanediol were mixed to form a paste, where the molar ratio of terephthalic acid to 1,3-propanediol was 1:1.25. 20 ppm cobalt acetate and 270 ppm Irganox 1076 were added to the terephthalic acid and 1,3-propanediol mixture. The paste for each sample was then gradually charged to an esterifier reactor over a period of 60 minutes, where the mass temperature in the esterifier reactor was maintained at a temperature of 250° C. and the reaction was conducted under a nitrogen pressure of 0.2 MPa. The esterification reaction for each sample was conducted until 80% of the terephthalic acid was consumed, a period of 221 minutes for the first sample, 220 minutes for the second sample, and 207 minutes for the third sample.

The esterification product of each sample was then transferred to a pre-polycondensation reactor. The esterification product was initially treated in the pre-polycondensation reactor at a temperature of 250° C. and a pressure of 0.15 MPa for a period 41 minutes for the first sample, 43 minutes for the second sample, and 62 minutes for the third sample. 60 ppm of a titanium catalyst and selected wt. % of a mixture of the phosphorous compound shown below was then added to the reaction mixture, where 0.75 wt. % of the phosphorous compound was added for the first sample, 1.5 wt. % of the phosphorous compound was added for the second sample, and 3.0 wt. % was added for the third sample.

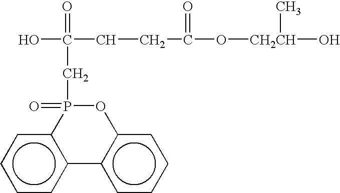

The pre-polycondensation reactor was then evacuated to a pressure of 2 kPa over a period of 25 minutes. After achieving vacuum pressure below 5 kPa the mass temperature in the reactor was increased to 265° C. in two steps.

After completing the 25 minute pressure drop in the pre-polycondensation reactor and the temperature increase, the reaction mass of each sample was transferred to a polymerization reactor. In the polymerization reactor, the reaction pressure was decreased to below 1 kPa and the mass temperature of the reaction mass of each sample was initially increased to 268° C. and then maintained at 264° C. for the duration of the polymerization process. Polymerization of the first sample was continued for 84 minutes, polymerization of the second sample was continued for 116 minutes, and polymerization of the third sample was continued for 84 minutes. The resulting co-polymer of each sample was then cooled and casted for solid state polymerization. The solid co-polymer of each sample was then solid state polymerized in a tumbler drier at a temperature of 205° C. for 7 hours to produce a final co-polymer product.

A control PTT polymer sample was prepared in the same manner as described above for the samples of the invention, except that no phosphorous compound was added in the pre-polycondensation step.

Properties of the final co-polymer samples are provided in Table 1.

TABLE 1

| | | CIE | CIE | CIE | % |
|---|---|---|---|---|---|
| | Intrinsic | Color | Color | Color | dipropylene |
| | Viscosity | L* | a | b | glycol ether |
| Sample 1 | 0.611 | 82.0 | −3.5 | −0.5 | 1.41 |
| 0.75 wt. % | | | | | |
| P compound | | | | | |
| Sample 2 | 0.71 | 81.9 | −4.0 | 5.4 | 1.44 |
| 1.5 wt. % | | | | | |
| P compound | | | | | |
| Sample 3 | 0.74 | 80.7 | −4.6 | 11.2 | 1.20 |
| 3.0 wt. % | | | | | |
| P compound | | | | | |

Tensile and strain properties of the final co-polymer samples and the control sample were measured in accordance with ASTM Method D638-02. The results are shown below in Table 2.

TABLE 2

| | Tensile | Strain at | Strain at | Offset Yield | Modulus |
|---|---|---|---|---|---|
| | Strength MPa | Ultimate % | Offset Yield % | Stress MPa | MPa |
| Control | Mean 58.8 | Mean 3.23 | Mean 1.97 | Mean 44.7 | Mean 2612 |
| | Std Dev 2.6 | Std Dev 0.30 | Std Dev 0.31 | Std Dev 3.3 | Std Dev 437 |
| Sample 1 | Mean 61.2 | Mean 3.16 | Mean 1.89 | Mean 46.7 | Mean 2873 |
| 0.75 wt. % | Std Dev 1.1 | Std Dev 0.24 | Std Dev 0.07 | Std Dev 1.1 | Std Dev 94 |
| P compound | | | | | |
| Sample 2 | Mean 59.7 | Mean 3.35 | Mean 2.08 | Mean 47.2 | Mean 2545 |
| 1.5 wt. % | Std Dev 0.7 | Std Dev 0.06 | Std Dev 0.04 | Std Dev 0.7 | Std Dev 26 |
| P compound | | | | | |
| Sample 3 | Mean 57.9 | Mean 2.95 | Mean 1.80 | Mean 42.6 | Mean 2894 |
| 3.0 wt. % | Std Dev 1.7 | Std Dev 0.14 | Std Dev 0.18 | Std Dev 2.3 | Std Dev 267 |
| P compound | | | | | |

The results provided in Table 2 show that the PTT co-polymer, unlike PET, does not lose tensile strength relative to the control PTT homopolymer as the phosphorous flame retardant co-monomer compound is added to form the PTT co-polymer in amounts up to 3 wt. % of the co-polymer.

That which is claimed is:

1. A flame retardant polyester composition comprised of a polymer containing from 50 mol % to 99.9 mol % of a trimethylene terephthalate component of formula (I) and from 0.1 mol % to 50 mol % of a phosphorous containing component of formula (II) 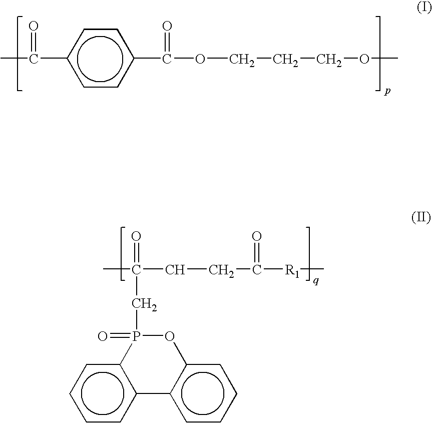
where p may be from 1 to 2500, q may be from 1 to 1250, and R₁ is an alkyl alcohol residuum having from 1 to 5 carbon atoms, an alkyl acid residuum having from 1 to 5 carbon atoms, an alkyl ester residuum having from 1 to 5 carbon atoms, or an oxygen atom where the composition has a tensile strength of at least 45 MPa.

2. The flame retardant polyester composition of claim 1 further comprising from 0.5 wt. % to 25 wt. % of a polyamide or a polyester other than the polymer formed of the trimethylene terephthalate component of formula (I) and the phosphorous containing component of formula (II).

3. The flame retardant polyester composition of claim 1 wherein the composition has a tensile strength of at least about 50 MPa.

4. The flame retardant polyester composition of claim 1 further comprising a filler.

5. The flame retardant polyester composition of claim 1 further comprising a non-fusible flame retardant component.

6. The flame retardant polyester composition of claim 1 further comprising a fusible flame retardant component.

7. The flame retardant polyester composition of claim 1 wherein the composition is a molded composition.

8. The flame retardant polyester composition of claim 1 wherein the composition is a film.

9. The flame retardant polyester composition of claim 1 wherein the composition is a melt blown fiber.

10. A process for producing a flame retardant polyester, comprising:
contacting 1) a trimethylene terephthalate containing material and 2) a phosphorous containing compound of Formula (V) where R₆ and R₇ may be the same or different and are a hydrogen atom, an alkyl hydrocarbon group having from 1 to 5 carbons, or an alkyl alcohol group having from 1 to 5 carbons and one or more alcohol substituents 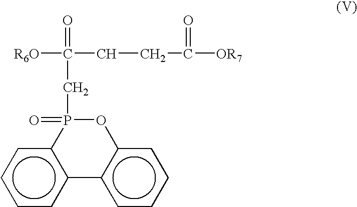
at a temperature of from 230° C. to 280° C. and a pressure of from 0.01 kPa to 20 kPa (0.1 mbar to 50 mbar) for a period of time effective to form a poly(trimethylene terephthalate) co-polymer having an intrinisic viscosity of at least 0.7 dl/g and a tensile strength of at least 45 MPa, where the amounts of the trimethylene terephthalate containing material and the phosphorous containing compound are selected to provide a mole ratio of trimethylene terephthalate to the phosphorous containing compound of from 1:1 to 999:1.

11. The process of claim 10 wherein the trimethylene terephthalate containing material and the phosphorous containing compound are contacted in the presence of a titanium or zirconium catalyst.

12. The process of claim 10 wherein the trimethylene terephthalate containing material is prepared by contacting 1,3-propanediol with terephthalaic acid or dimethylterephthalate at a pressure of from 70 kPa to 550 kPa and a temperature of from 235° C. to 280° C.

13. The process of claim 10 wherein the phosphorous containing compound of formula (V) is prepared by contacting 9,10-dihydro-9-oxa-10-phosphaphenanthrene-10-oxide with itaconic acid and optionally an alkyl alcohol having from 1 to 5 carbon atoms and having one or more alcohol substituents at a temperature of from 120° C. to 200° C.

14. The process of claim 10 wherein the trimethylene terephthalate containing material and the phosphorous containing compound of formula (V) are contacted initially at a pressure of from 0.2 kPa to 20 kPa and a temperature of from 230° C. to 280° C. for a period of from 10 minutes to 4 hours and subsequently at a pressure of from 0.02 kPa to 0.25 kPa and a temperature of from 240° C. to 275° C. for a period effective to form the poly(trimethylene terephthalate) containing co-polymer having an intrinsic viscosity of at least 0.7 dl/g.

15. A process for producing a flame retardant polyester, comprising,
contacting 1,3-propanediol, a compound selected from the group consisting of terephthalic acid, dimethylterephthalate, and mixtures thereof, and a phosphorous containing compound of formula (V) 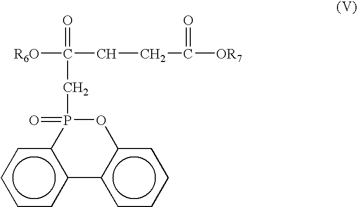
where R₆ and R₇ may be the same or different and are a hydrogen atom, an alkyl hydrocarbon group having from 1 to 5 carbon atoms, or an alkyl alcohol group having from 1 to 5 carbon atoms and one or more alcohol substituents at a temperature of from 235° C. to 280° C. and a pressure of from 70 kPa to 550 kPa to form an esterification product;
treating the esterification product at a temperature of from 230° C. to 280° C. and a pressure of from 0.01 kPa to 20 kPa for a period of time effective to form a poly(trimethylene terephthalate) co-polymer having an intrinisic viscosity of at least 0.7 dl/g;
wherein the amounts 1,3-propanediol, the compound selected from the group consisting of terephthalic acid, dimethylterephthalate, and mixtures thereof, and the phosphorous containing compound are selected to provide the poly(trimethylene terephthalate) co-polymer with from 50 mol % to 99.9 mol % trimethylene terephthalate monomer in the co-polymer.

16. The process of claim 15 wherein the esterification product is treated at a temperature of from 230° C. to 280° C. and a pressure of from 0.01 kPa to 20 kPa in the presence of a titanium or zirconium catalyst to form the poly(trimethylene terephthalate) co-polymer.

17. The process of claim 15 wherein the 1,3-propanediol, the compound selected from the group consisting of terephthalic acid, dimethylterephthalate, and mixtures thereof, and the phosphorous containing compound of formula (V) are contacted in the presence of a titanium or zirconium catalyst.

18. The process of claim 15 wherein the phosphorous containing compound of formula (V) is prepared by contacting 9,10-dihydro-9-oxa-10-phosphaphenanthrene-10-oxide with itaconic acid and optionally an alkyl alcohol having from 1 to 5 carbon atoms and having one or more alcohol substituents at a temperature of from 120° C. to 200° C.

19. The process of claim 15 wherein the esterification product is treated initially at a pressure of from 0.2 kPa to 20 kPa and a temperature of from 230° C. to 280° C. for a period of from 10 minutes to 4 hours and subsequently at a pressure of from 0.02 kPa to 0.25 kPa and a temperature of from 240° C. to 275° C. for a period effective to form the poly(trimethylene terephthalate) containing co-polymer having an intrinsic viscosity of at least 0.7 dl/g.

20. A process for producing a flame retardant polyester, comprising:
contacting 1,3-propanediol, a compound selected from the group consisting of terephthalic acid, dimethylterephthalate, and mixtures thereof, 9,10-dihydro-9-oxa-10-phosphaphenanthrene-10-oxide, itaconic acid and optionally an alkyl alcohol having from 1 to 5 carbon atoms and having one or more alcohol substituents at a temperature of from 235° C. to 280° C. and a pressure of from 70 kPa to 550 kPa to form an esterification product;
treating the esterification product at a temperature of from 230° C. to 280° C. and a pressure of from 0.01 kPa to 20 kPa for a period of time effective to form a poly(trimethylene terephthalate) co-polymer having an intrinisic viscosity of at least 0.7 dl/g and a tensile strength of at least 45 MPa;
wherein the amounts 1,3-propanediol, the compound selected from the group consisting of terephthalic acid, dimethylterephthalate, and mixtures thereof, the 9,10-dihydro-9-oxa-10-phsphaphenanthrene-10-oxide, and the itaconic acid are selected to provide the poly(trimethylene terephthalate) co-polymer with from 50 mol % to 99.9 mol % trimethylene terephthalate monomer in the co-polymer.

21. The process of claim 20 wherein the esterification product is treated at a temperature of from 230° C. to 280° C. and a pressure of from 0.01 kPa to 20 kPa in the presence of a titanium or zirconium catalyst.

22. The process of claim 20 wherein the 1,3-propanediol, the compound selected from the group consisting of terephthalic acid, dimethylterephthalate, and mixtures thereof, the 9,10-dihydro-9-oxa-10-phosphaphenanthrene-10-oxide, the itaconic acid and optionally the alkyl alcohol having from 1 to 5 carbon atoms and having one or more alcohol substituents are contacted in the presence of a titanium or zirconium catalyst.

23. The process of claim 20 wherein the esterification product is treated initially at a pressure of from 0.2 kPa to 20 kPa and a temperature of from 230° C. to 280° C. for a period of from 10 minutes to 3 hours and subsequently at a pressure of from 0.02 kPa to 0.25 kPa and a temperature of from 240° C. to 275° C. for a period effective to form the poly(trimethylene terephthalate) containing co-polymer having an intrinsic viscosity of at least 0.7 dl/g.
